(19) United States
(12) Patent Application Publication
(10) Pub. No.: US 2007/0182197 A1
(43) Pub. Date: Aug. 9, 2007

(54) Water Catcher

(76) Inventor: William T. Held, Elma, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 11/671,266

(22) Filed: Feb. 5, 2007

Related U.S. Application Data
(60) Provisional application No. 60/765,083, filed on Feb. 3, 2006.

(51) Int. Cl. B62D 25/13

(52) U.S. Cl. 296/77.1

(57) ABSTRACT

The invention is a device for catching and channeling water from a cart roof to the ground. The water catcher may include an inlet cup able to receive water from the roof of a cart; such as a golf cart. The inlet cup may be positioned so as not to touch the roof of the cart. The water catcher may also include a drain tube connected to the inlet cup and able to carry water from the inlet cup to the ground.

### CROSS-REFERENCE TO RELATED APPLICATION

This application claims the benefit of priority to U.S. provisional patent application Ser. No. 60/765,083, filed on Feb. 3, 2006.

### FIELD OF THE INVENTION

The present invention relates to devices for gathering water from the roof of a cart, such as a golf cart.

### BACKGROUND OF THE INVENTION

The prior art includes devices that gather water from the roof of a cart and deliver the water to the ground. However, the prior art devices require contact with the roof. Some of the prior art devices also require that holes be made in the roof, thereby increasing the manufacturing cost and diminishing the structural characteristics of the roof.

The prior art also includes canopies for selectively covering the rear storage area of a cart. Such canopies may be deployed to cover the storage area when it is desired to protect the contents of the storage area, for example from rain or sun. Some such canopies include bridging-devices for carrying water from the roof to the canopy so that water will not descend onto the occupants of the cart, or the contents of the storage area. However, the bridging-devices significantly increase the cost of the canopy system and require contact with the cart roof. Contact with the cart roof is not desirable since the roof may be defaced by the bridging-device. Further, contact with the roof by a bridging-device results in noise being generated when the canopy and the cart are moving, or when wind blows against the canopy and/or the cart.

### SUMMARY OF THE INVENTION

The invention includes a water catcher mounted on a cart canopy system. The water catcher may include an inlet cup able to receive water from a roof of a cart such as a golf cart. The inlet cup may be positioned so as not to touch the roof of the cart. The water catcher may also include a drain tube connected to the inlet cup and able to carry water from the inlet cup to ground.

The inlet cup may have a lower edge that is positioned under the cart roof when the canopy system is installed on the cart. Further, the inlet cup may have an upper edge that is positioned behind the cart roof when the canopy system is installed on the cart. The upper edge of the inlet cup may be positioned at an elevation that is higher than a rear edge of the cart roof, when the canopy system is installed on the cart.

The water catcher may be mounted to a housing of the canopy system, or the water catcher may be mounted to a support bar of the canopy system.

The invention may include a roof, having a raised perimeter edge. The perimeter edge may have an exit for allowing water to flow off the roof and into the inlet cup. The roof may include ribs oriented in a direction similar to the direction in which a cart moves when the cart is being driven straight ahead. These ribs inhibit the flow of water from side-to-side.

The roof may include ribs oriented in a direction different from the direction in which a cart moves when the cart is being driven straight ahead. These ribs inhibit the flow of water toward the inlet cup, so that the velocity of the water is reduced.

### BRIEF DESCRIPTION OF THE DRAWINGS

For a fuller understanding of the nature and objects of the invention, reference should be made to the accompanying drawings and the subsequent description. Briefly, the drawings are:

FIG. 1A is a side view of part of a cart having a canopy system, a housing and a device according to the invention;

FIG. 1B is similar to FIG. 1A, except that the there is no housing used;

FIG. 2 depicts a housing and water catcher like that shown in FIG. 1A;

FIG. 3 depicts a housing like that shown in FIG. 1A and a variation of the water catcher;

FIG. 4 is a rear view of the cart depicted in FIG. 1A; and

FIG. 5 is a top view of the cart and canopy depicted in FIG. 1A.

### FURTHER DESCRIPTION OF THE INVENTION

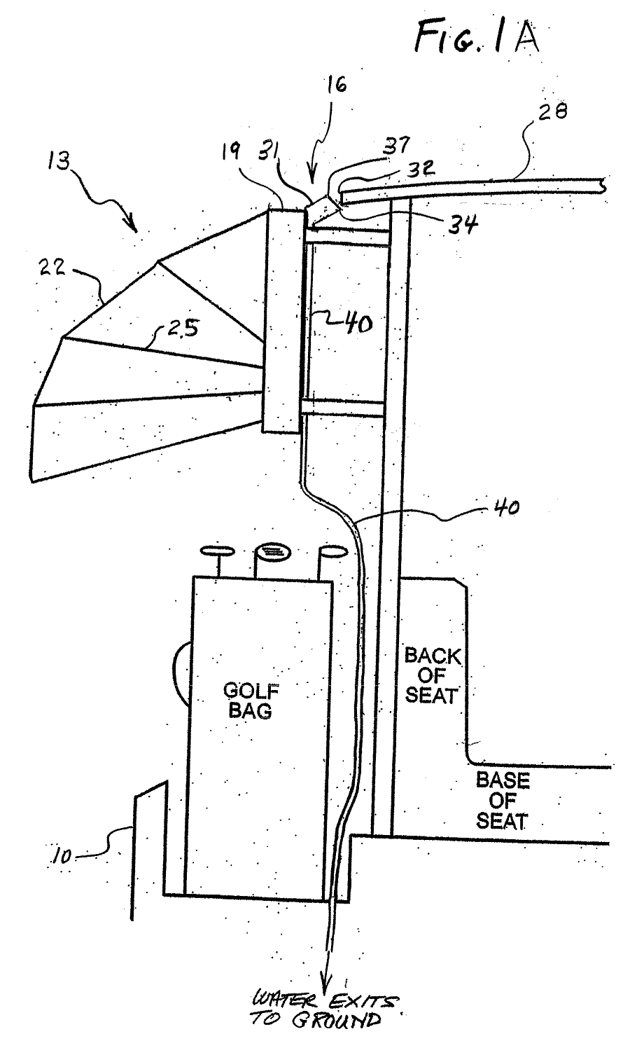

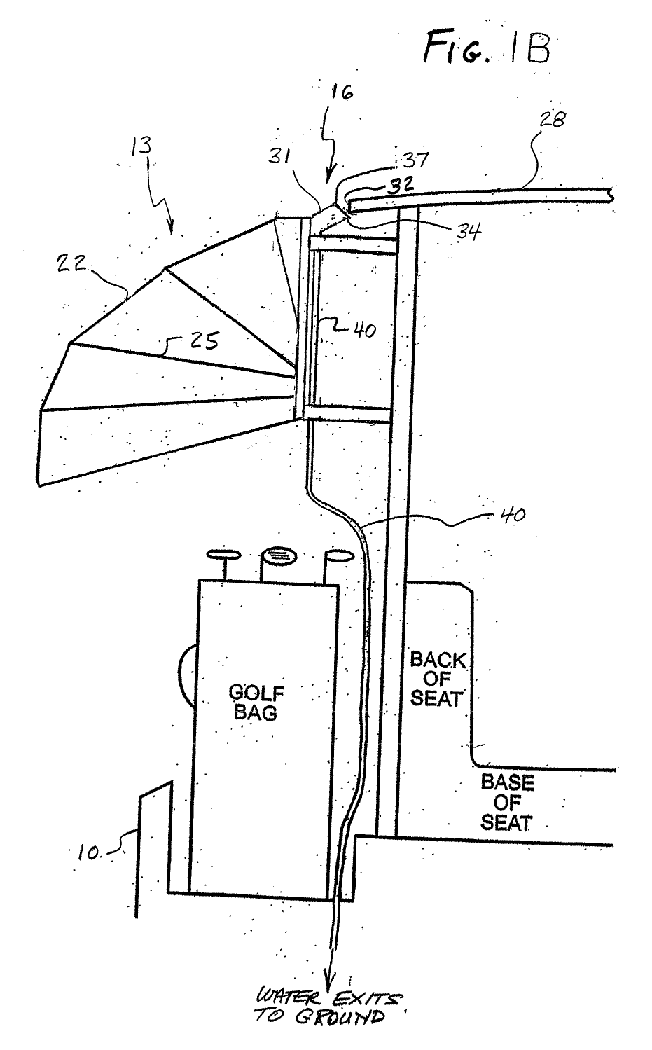

FIG. 1A depicts a cart 10 having a canopy system 13 and a water catcher 16 that is in keeping with the invention. The canopy system 13 is depicted in the deployed position. The canopy system 13 includes a housing 19 within which the canopy 22 may be stored when the canopy 22 is not deployed.

In FIG. 1A, the water catcher 16 is shown mounted on the housing 19. However, the invention is not limited to canopy systems 13 having a housing 19, and FIG. 1B shows an arrangement in which the water catcher 16 is mounted on a support bar 25 of the canopy system 13.

In FIG. 1A and FIG. 1B, the water catcher 16 is mounted near the cart roof 28, but does not touch the cart roof 28. In doing so, the roof 28 will not be damaged by the water catcher 16 during use.

The water catcher 16 may have an inlet cup 31 into which water from the roof 28 may enter. As water travels off the cart roof 28, the water enters the water catcher 16 through the inlet cup 31.

The inlet cup 31 may include a lower edge 34 and an upper edge 37. The lower edge 34 of the inlet cup 31 may be positioned under the cart roof 28 so as to catch water flowing off the roof 28 when the water has a large (relatively speaking) velocity vector in the direction of the force of gravity. Positioning the lower edge 34 in this fashion will be advantageous for catching water when the cart 10 is stationary.

The upper edge 37 of the inlet cup 31 may be positioned away from the cart roof 28, and may rise to an elevation that is greater than the elevation of a rear edge 32 of the cart roof 28, so as to catch water that has a large (relatively speaking) velocity vector that is perpendicular to the force of gravity. The upper edge 37 of the inlet cup 31 is shown in FIGS. 1A and 1B behind the cart roof 28. Positioning the upper edge 37 of the inlet cup 31 in this fashion will be advantageous for catching water when the cart 10 is accelerating.

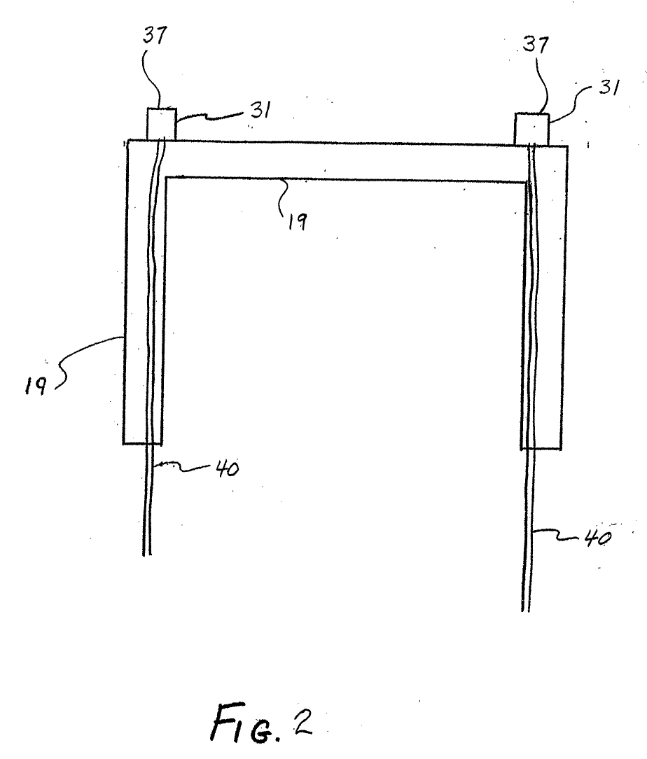

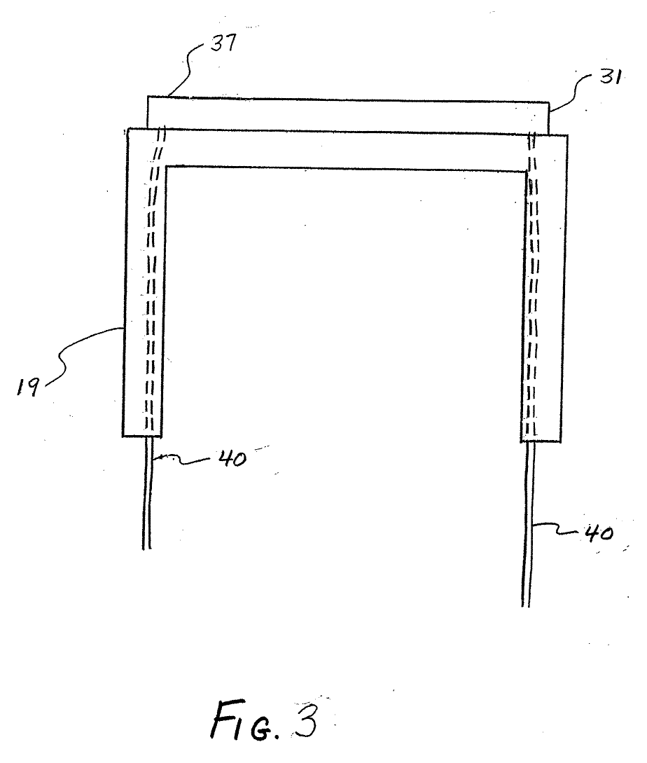

The inlet cup 31 may lead to a drain tube 40, which is able to carry water from the inlet cup 31 to the ground. FIGS. 1A and 1B show a drain tube 40 mounted on an external surface of the housing 19. FIG. 2 shows the drain tube 40 mounted on an external surface of the housing. FIG. 3 shows an alternate embodiment in which the drain tube 40 extends through a wall of the housing 19 and runs through the housing 19. FIG. 3 also shows that the inlet cup 31 may extend substantially the width of the housing 19. It will be recognized that the width of the inlet cup 31 may be substantially the width of the roof 28 or of the canopy support bar 25.

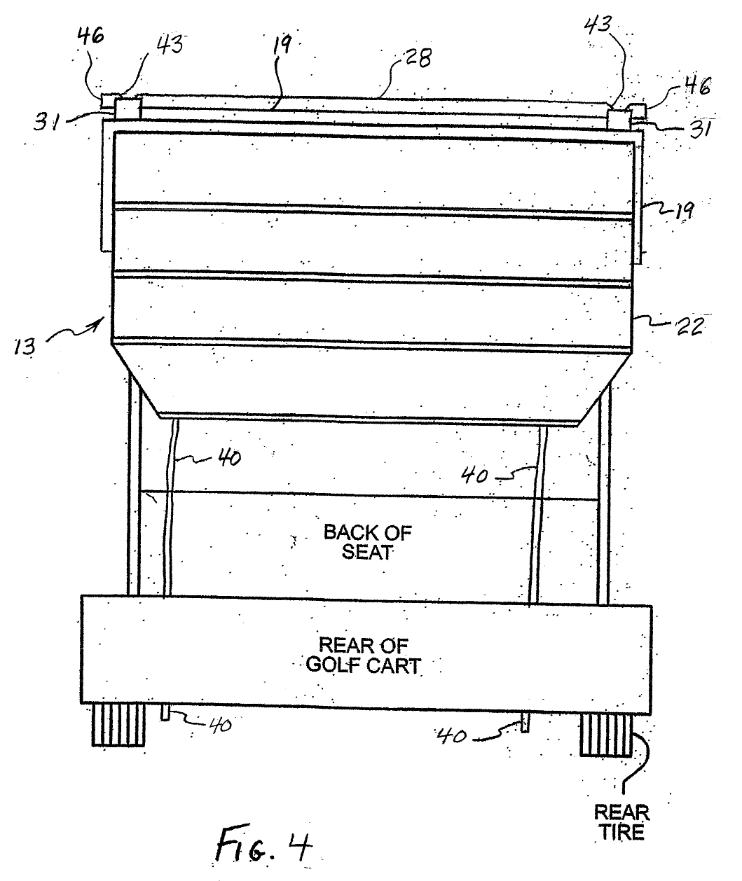

FIG. 4 shows a water catcher 16 installed on a housing 19, and a roof 28 having two exits 43. Each of the exits 43 is shown positioned near one of the inlet cups 31. The exits 43 depicted in FIG. 4 are positioned near the rear corners 46 of the roof 28.

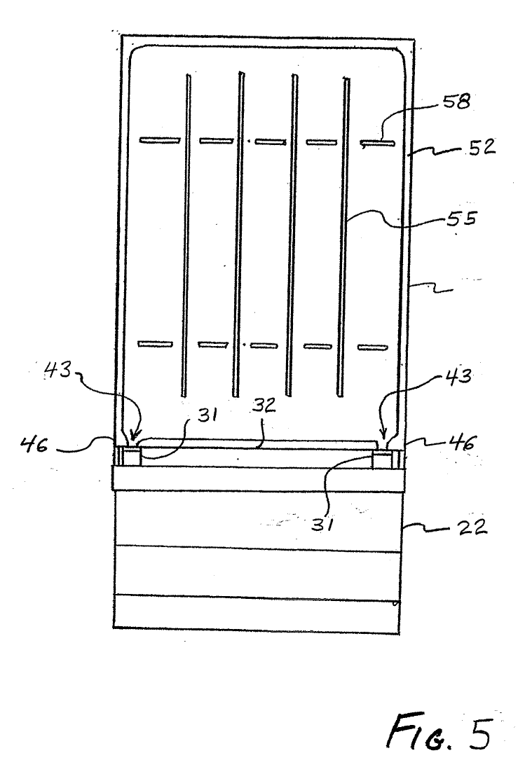

FIG. 5 is a top view of the roof 28 shown in FIG. 4. The roof 28 may include an outer rim 52 to prevent water from flowing off the roof 28. The exits 43 may be areas where the height of the rim 52 is less than other portions of the rim 52. In this fashion, water may be allowed to flow off the roof 28 only at the exits 43. The inlet cups 31 may be positioned near the exits 43 so that water is caught by the inlet cups 31 once water moves through the exits 43.

The roof 28 may include ribs 55, 58 either for the purpose of directing the flow of water, or to provide structural rigidity to the roof, or both. For example, longitudinal ribs 55 may be provided in a first direction that is similar to the direction in which the cart 10 moves when being driven straight ahead. When provided to channel water, the longitudinal ribs 55 may inhibit water flow in a direction that is perpendicular to the direction in which the cart 10 moves when being driven straight ahead.

Cross ribs 58 may be provided on the roof 28 either for the purpose of inhibiting the flow of water, or to provide structural rigidity, or both. For example, cross ribs 58 may be provided in a first direction that is different from the direction in which the cart 10 moves when being driven straight ahead. When provided to inhibit the flow of water, the cross ribs 58 may reduce the velocity of water relative to the roof 28, and thereby inhibit water flow when the cart 10 is accelerating.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A water catcher mounted on a cart canopy system, comprising:
an inlet cup able to receive water from a roof of a cart; and
a drain tube connected to the inlet cup and able to carry water from the inlet cup to ground.

2. The water catcher of claim 1, wherein the inlet cup has a lower edge that is positioned under the cart roof when the canopy system is installed on the cart.

3. The water catcher of claim 2, wherein the inlet cup has an upper edge that is positioned behind the cart roof when the canopy system is installed on the cart.

3. The water catcher of claim 2, wherein the inlet cup has an upper edge that is positioned at an elevation that is higher than the cart roof, when the canopy system is installed on the cart.

4. The water catcher of claim 1, wherein the catcher is mounted on a canopy housing.

5. The water catcher of claim 1, wherein the catcher is mounted on a support bar of the canopy system.

6. A water catching system, comprising:
a roof having a raised perimeter edge, the perimeter edge having an exit for allowing water to flow off the roof;
an inlet cup, not in contact with the roof, for accepting water from the exit;
a drain for accepting and carrying water from the inlet cup to ground.

7. The system of claim 6, wherein the roof includes ribs oriented in a direction similar to the direction in which a cart moves when the cart is being driven straight ahead.

8. The system of claim 6, wherein the roof includes ribs oriented in a direction different from the direction in which a cart moves when the cart is being driven straight ahead.
